(19) United States
(12) Patent Application Publication
(10) Pub. No.: US 2016/0008832 A1
(43) Pub. Date: Jan. 14, 2016

(54) Device Of Spray Gun For Preventing Liquid From Flowing Backward

(71) Applicant: Tsung Mao Industrial Co., Ltd., New Taipei City (TW)

(72) Inventor: Jung-Kun Huang, New Taipei City (TW)

(21) Appl. No.: 14/329,995

(22) Filed: Jul. 14, 2014

(51) Int. Cl. B05B 9/04

(52) U.S. Cl. CPC B05B 9/04

(57) ABSTRACT

A spray gun includes a body in which a motor unit is received. A cylinder is located in the barrel of the spray gun. A cap is connected to the barrel and a container is connected to the cap. A pressure-charging path and a paint path are connected to the cylinder. A hose is located in the container and connected with the paint path. The air pressure from the motor unit enters into the container via the pressure-charging path to pump the paint in the container to the nozzle. A circular pressure-charging member is mounted to the hose and connected to the cylinder. The pressure-charging member is located in the container. An aperture is defined through the pressure-charging member and communicates with the container. The paint in the container is separated from the pressure-charging path by the pressure-charging member and cannot flow back through the aperture.

### BACKGROUND OF THE INVENTION

(1) Fields of the Invention

The present invention relates to a device of a spray gun, and more particularly, to a device of a spray gun to prevent liquid in the spray gun from flowing backward.

(2) Descriptions of Related Art

The conventional spray gun 10 is disclosed in FIG. 1 and comprises body 11, a barrel 12, a handle 13 and a container 17, wherein the body 11 has a room 111 defined therein. A motor 112 and a turbine 113 are located in the room 111. The turbine 113 is driven by the motor 112. A cover 114 and an outer cover 115 are located above the body 11 to seal the room 111. Each of the cover 114 and the outer cover 115 has an inlet to introduce air into the room 111. The barrel 12 has a nozzle 121. The room 111 extends to the interior of the barrel 12 so that the barrel 12 receives the air from the body 11. The barrel 12 has a cylinder 14 received therein which is connected to or integrally formed with a cap 15. The cap 15 is connected to the container 17. A trigger 16 is located the underside of the barrel 12 and is pushed to move the tubular member 141 in the cylinder 14. A first spring 142 and a second spring 143 and a probe 144 are located in the tubular member 141. The tubular member 141 contacts the first spring 142 to position the tubular member 141 which is moved when applied by a force. The probe 144 is located in the tubular member 141 and a paint path 145, and the second spring 143 is mounted to the rear end of the probe 144. The tubular member 141 has a contact end 1411 which contacts and activates two resilient plates 132 of a micro switch 131 to activate the motor 112 and the turbine 113. The front end of the probe 144 is located in the nozzle 121. The probe 144 is moved back and forth to open or close the nozzle 121. The cylinder 14 has a downward paint path 145 and a pressure-charging path 146, the paint path 145 receives the paint from the hose 171 of the container 17, and the pressure-charging path 146 introduces the air from the motor 112 and the turbine 113 into the container 17. An air path 147 is located outside of the paint path 145. By pulling the trigger 16, the micro switch 131 is activated and the motor 112 and the turbine 113 are operated. The air of the motor 112 and the turbine 113 passes through the pressure-charging path 146 and reaches the container 17, so that the pressure in the container 17 is increased and the paint in the container 17 is sucked by the hose 171 of the cap 15 to the paint path 145. The tubular member 141 moves backward to pull the probe 144, the second spring 143 contacts the probe 144, and the first spring 142 contacts the tubular member 141, so that the probe 144 or the tubular member 141 can be returned to its initial position. The movement of the trigger 16 decides the volume of the paint that is ejected from the nozzle 121. The paint that is not ejected from the nozzle 121 flows back to the container 17 via the paint path 145.

When the spray gun is not in use, the paint that is not ejected from the nozzle 121 and stays in the container 17 and the paint path 145 flows back to the cylinder 14, the first spring 142, the second spring 143 and the probe 144 via the paint path 145. Besides, when using the spray gun at an angle, a large amount of the paint enters into the pressure-charging path 146 and may flows to the motor 112 to generate a circuit short of the motor 112.

Some spray guns use electro-magnetic device or pressure-charging motor, or is connected with an exterior compressor may have the same problem of circuit short of the motor by being in contact with the paint.

The present invention intends to provide a spray gun that eliminates the shortcomings mentioned above.

### SUMMARY OF THE INVENTION

The present invention relates to a spray gun and comprises a body and a motor unit is located in the body. A barrel is connected to the front end of the body and a nozzle is connected to the front end of the barrel. A handle is connected to the barrel and a cylinder is located in the barrel. A cap is connected to the barrel and a container is connected to the cap. A pressure-charging path and a paint path are connected to the cylinder. A hose is located in the container and connected with the paint path. Air pressure from the motor unit enters into the container via the pressure-charging path so that the paint in the container is pumped to the nozzle via the hose, the paint path and the cylinder. A circular pressure-charging member is mounted to the hose and connected to the cylinder. The pressure-charging member is located in the container. The pressure-charging path communicates with the interior of the pressure-charging member. At least one aperture is defined through the wall of the pressure-charging member and communicates with the interior of the container. The paint in the container is separated from the pressure-charging path by the pressure-charging member and cannot flow back through the at least one aperture.

The primary object of the present invention is to provide a spray gun that has a circular pressure-charging member is located in and communicates with the container. At least one aperture is defined through the wall of the pressure-charging member and communicates with the interior of the container. The paint in the container is separated from the pressure-charging path by the pressure-charging member and cannot flow back through the at least one aperture.

Another object of the present invention is to provide a spray gun wherein the paint does not flow to be in contact with the motor even when the spray gun is used at an angle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view of a conventional spray gun;

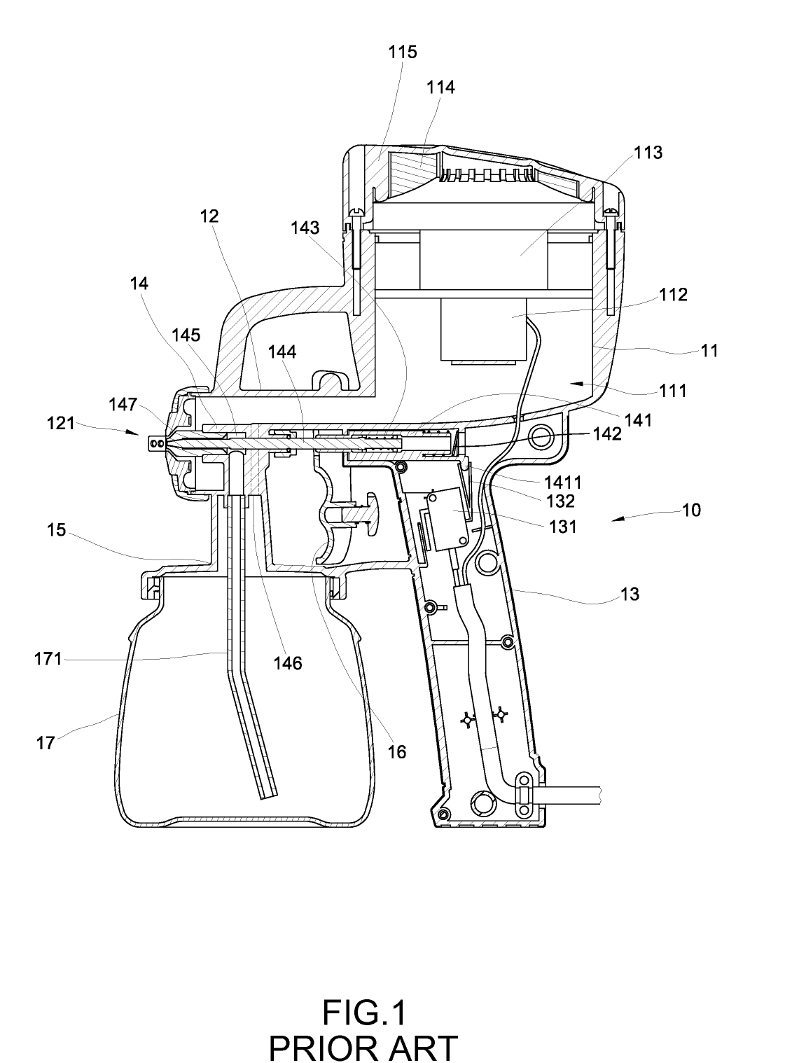

FIG. 2 is an exploded view of the spray gun of the present invention, and

FIG. 3 is a cross sectional view of the spray gun of the present invention.

### DETAILED DESCRIPTION OF THE PREFERRED EMBODIMENT

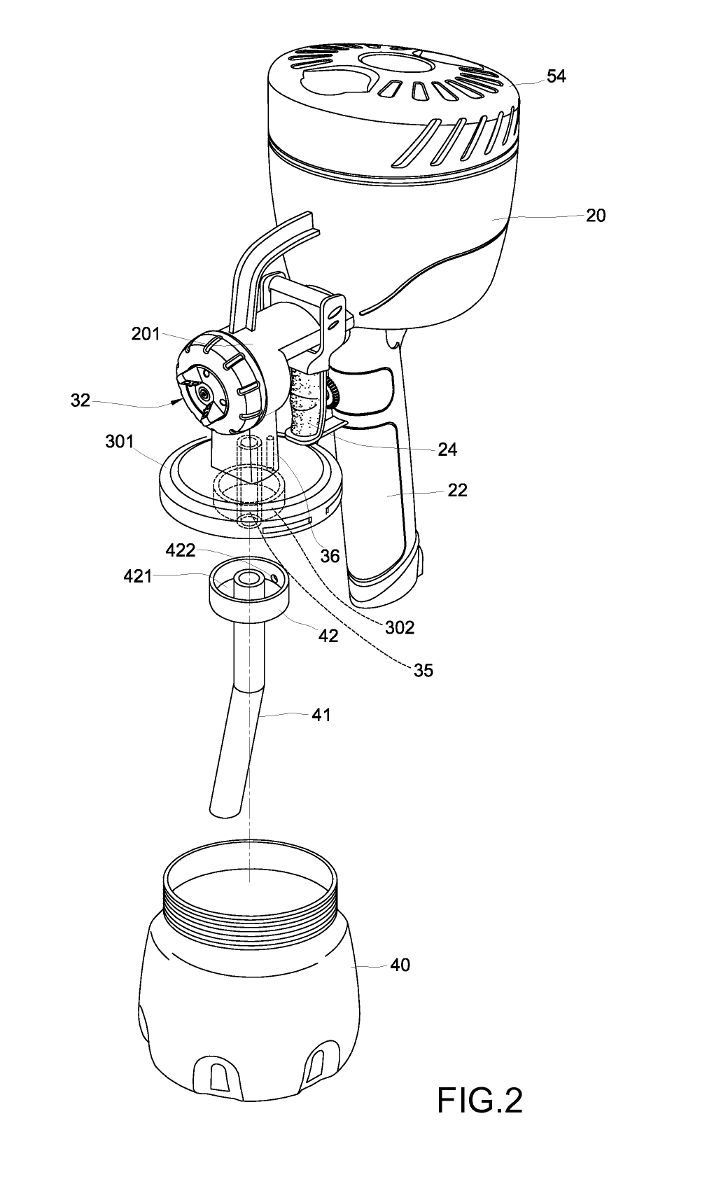

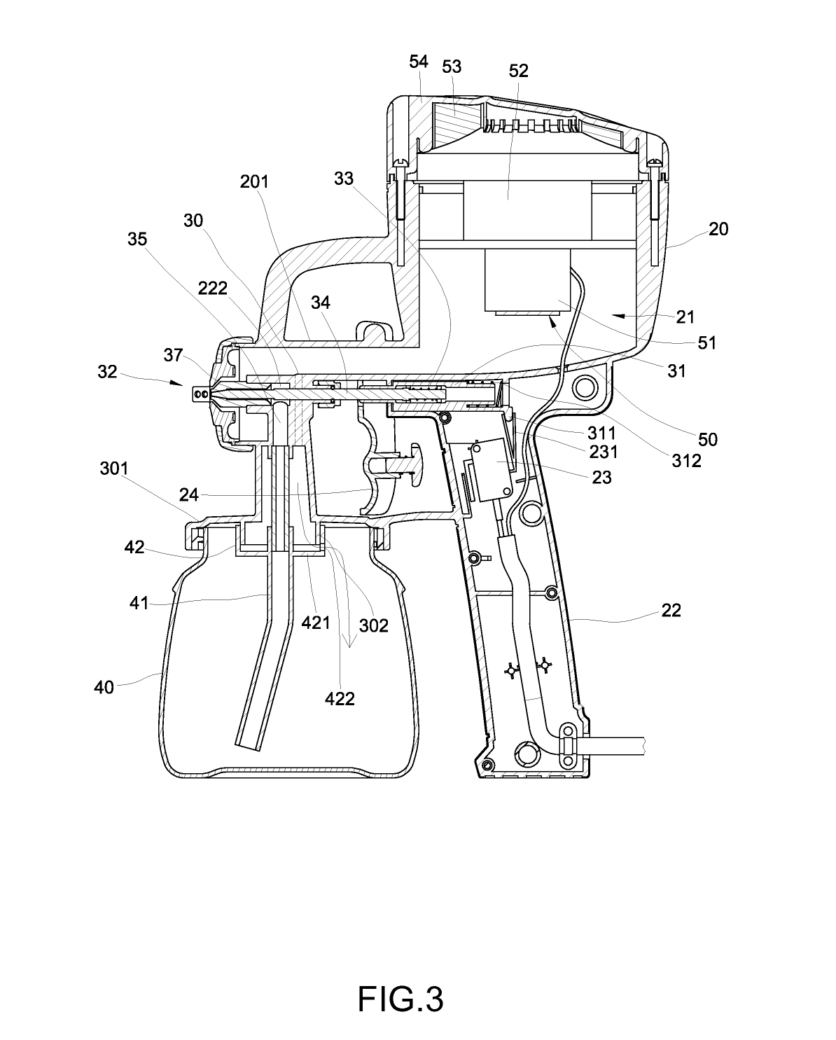

Referring to FIGS. 2 to 3, the spray gun of the present invention comprises a body 20, a cylinder 30, a cap 301, a container 40 and a motor unit 50.

The body 20 has a room 21 defined therein and the motor unit 50 is received in the room 21. The motor unit 50 comprises a motor 51 and a turbine 52 which is driven by the motor 51. A barrel 201 is connected to the front end of the body 20 and a nozzle 32 is connected to the front end of the barrel 201. A trigger 24 is movably connected to the barrel 201. A handle 22 is connected to the barrel 201. The cylinder 30 is located in the barrel 201 and the cap 301 is connected to the barrel 201. The cylinder 30 has a tube 302 extending therefrom. The container 40 is connected to the cap 301. A downward pressure-charging path 36 and a downward paint path 35 are connected to the cylinder 30. The paint path 35 and the pressure-charging path 36 are located within the area that the tube 302 encloses. A hose 41 is located in the container 40 and connected with the paint path 35.

A cover 53 and a mounting member 54 are connected to the top of the body 20. Each of the cover 53 and the mounting member 54 has an inlet. The cylinder 30 and the cap 301 are integrally formed as a one-piece. The cylinder 30 has a tubular member 31, a first spring 312, a second spring 33 and a probe 34 received therein. The rear end of the probe 34 is located in the tubular member 31. The second spring 33 is mounted to the rear end of the probe 34. The front end of the probe 34 is located in the nozzle 32. A contact end 311 is formed on the distal end of the tubular member 31.

When the trigger 24 is pulled, the tubular member 31 compresses the first spring 312 and contacts two resilient plates 231 of a micro switch 23 to activate the micro switch 23. The micro switch 23 activates the motor unit 50. An air path 37 is formed around the paint path 35. The probe 34 is moved back and forth to open the nozzle 32 or close the nozzle 32.

A circular pressure-charging member 42 is an annular member with an inner bottom 421 connected to the wall of the pressure-charging member 42. The wall of the pressure-charging member 42 is mounted to the tube 302 of the cylinder 30. The pressure-charging member 42 is mounted to the hose 41 which extends through the center of the pressure-charging member 42. In this embodiment, pressure-charging member 42 and the hose 41 are integrally formed as a one-piece.

The pressure-charging member 42 is located in the container 40. The pressure-charging path 36 communicates with the interior of the pressure-charging member 42. At least one aperture 422 is defined through the wall of the pressure-charging member 42 and communicates with the interior of the container 40.

When pulling the trigger 24, the micro switch 23 is activated which activates the motor 51 and the turbine 52 to generate air pressure. The air pressure from the motor unit 50 enters into the container 40 via the pressure-charging path 36, the pressure-charging member 42 and the at least one aperture 422. The pressure in the container 40 is increased and the paint in the container 40 is pumped to the nozzle 32 and sprayed via the hose 41, the paint path 35 and the cylinder 30. The tubular member 31 is moved to pull the probe 34 which contacts the second spring 33 and the first spring 312 contacts the tubular member 31. The paint is sprayed from the nozzle 32. The amount of the paint that is sprayed from the nozzle 32 is decided by the distance that the trigger 24 is pulled.

The paint in the container 40 is separated from the pressure-charging path 36 by the pressure-charging member 42. Because the at least one aperture 422 is a small aperture so that the paint cannot flow back through the at least one aperture 422.

Because the at least one aperture 422 communicates with the interior of the container 40, so that the air pressure of the container 40 can be increased via the at least one aperture 422. The pressure-charging member 42 prevents the paint in the container 40 from entering into the pressure-charging path 36. The at least one aperture 422 is a small aperture so that the paint cannot flow back to the pressure-charging path 36, the cylinder 30 and the motor unit 50 through the at least one aperture 422.

The at least one aperture 422 of the pressure-charging member 42 can be made at desired position and size according to the size of the container 40 so as to prevent the paint in the container 40 from passing through the at least one aperture 422. When the spray gun is used at an angle, the paint will not enter into the pressure-charging path 36 in a great amount so as to protect the motor 51 from being in contact with the paint.

While we have shown and described the embodiment in accordance with the present invention, it should be clear to those skilled in the art that further embodiments may be made without departing from the scope of the present invention.

What is claimed is:

1. A spray gun comprising:
a body and a motor unit located in the body;
a barrel connected to a front end of the body and a nozzle connected to a front end of the barrel, a handle connected to the barrel, a cylinder located in the barrel, a cap connected to the barrel and a container connected to the cap, a pressure-charging path and a paint path connected to the cylinder, a hose located in the container and connected with the paint path, air pressure from the motor unit entering into the container via the pressure-charging path, paint in the container being pumped to the nozzle via the hose, the paint path and the cylinder, and
a circular pressure-charging member mounted to the hose and connected to the cylinder, the pressure-charging member located in the container, the pressure-charging path communicating with an interior of the pressure-charging member, at least one aperture defined through a wall of the pressure-charging member and communicating with an interior of the container, the paint in the container being separated from the pressure-charging path by the pressure-charging member and cannot flow back through the at least one aperture.

2. The spray gun as claimed in claim 1, wherein the motor unit comprises a motor and a turbine which is driven by the motor.

3. The spray gun as claimed in claim 1, wherein the cylinder has a tube extending therefrom and the pressure-charging member is mounted to the tube, the paint path and the pressure-charging path are located within an area that the tube encloses.

4. The spray gun as claimed in claim 1, wherein the pressure-charging member has an inner bottom.

5. The spray gun as claimed in claim 1, wherein the body has a room defined therein, the motor unit is located in the room, a cover and a mounting member are connected to a top of the body, each of the cover and the mounting member has an inlet, the cylinder and the cap are integrally formed as a one-piece, the cylinder has a tubular member, a first spring, a second spring and a probe received therein, a trigger is movably connected to the barrel, a rear end of the probe is located in the tubular member, the second spring is mounted to the rear end of the probe, a front end of the probe is located in the nozzle, a contact end is formed on a distal end of the tubular member, when the trigger is pulled, the tubular member compresses the first spring and contacts two resilient plates of a micro switch to activate the micro switch, the micro switch activates the motor unit, an air path is formed around the paint path.
